(19) United States
(12) Patent Application Publication
(10) Pub. No.: US 2025/0210778 A1
(43) Pub. Date: Jun. 26, 2025

(54) BATTERY WITH LONGITUDINAL CLAMPING FOR AN ELECTRIC OR HYBRID VEHICLE, AND METHOD OF ASSEMBLING SUCH A BATTERY

(71) Applicant: AUTOMOTIVE CELLS COMPANY SE, BRUGES (FR)

(72) Inventors: Pierre CHAUVEAU, BRUGES (FR); Alexandre MATHIEU, BORDEAUX (FR); Patrick BRIEN, PAREMPUYRE (FR); Dimitri MARATHE, VILLENAVE D’ORNON (FR)

(21) Appl. No.: 18/852,329

(22) PCT Filed: Mar. 30, 2023
(86) PCT No.: PCT/EP2023/058359

§ 371 Date: Sep. 27, 2024

(30) Foreign Application Priority Data
Mar. 31, 2022 (EP) 22305413.1

(51) Int. Cl. H01M 50/249; H01M 50/238; H01M 50/242; H01M 50/264; H01M 50/291

(52) U.S. Cl. CPC H01M 50/249; H01M 50/238; H01M 50/242; H01M 50/264; H01M 50/291

(57) ABSTRACT

Disclosed is a battery, for an electric or hybrid vehicle, comprising:
a casing defining a housing that extends in a longitudinal direction and a transverse direction,
a plurality of cross-members attached to the casing and extending in the transverse direction between a first lateral edge and a second lateral edge of the casing, and
a plurality of assemblies comprising electrochemical cells that extend successively in the transverse direction and are secured to one another,
   the cross-members and the assemblies being arranged successively against one other in the longitudinal direction in the housing so that there is no mechanical clearance between the cross-members and the assemblies, the assemblies and/or cross-members being attached to the casing.

### CROSS-REFERENCE TO RELATED APPLICATIONS

This application is the U.S. national phase of International Application No. PCT/EP2023/058359 filed Mar. 30, 2023, which designated the U.S. and claims priority to EP 22305413.1 filed Mar. 31, 2022, the entire contents of each of which are hereby incorporated by reference.

### TECHNICAL FIELD

The present invention relates to an electrical battery.

The present invention further relates to a method of assembling elements of such a battery.

### BACKGROUND

The invention applies more particularly to the production of a battery, in particular for an electric or hybrid vehicle. The term “battery” refers to a plurality of electrochemical cells electrically connected to each other. According to a particular example of a battery, the plurality of electrochemical cells is arranged in the form of one or a plurality of module(s), each module comprising a plurality of electrochemical cells electrically connected to one another and mechanically assembled to one another by an assembly system, such as assembly plates. An electrochemical cell comprises, more particularly, a stack of positive electrodes connected to one another, and a stack of negative electrodes connected to one another, separated by a separator. The positive electrodes connected to each other form a positive terminal, and the negative electrodes connected to each other form a negative terminal.

The battery generally includes a casing participating in the protection of the internal elements thereof, more particularly the electrochemical cells and the electrical connectors. In order to enable the battery to withstand impacts, e.g. lateral impacts, possibly suffered by the vehicle, the casing includes fastened cross-members extending between two lateral edges of the casing opposite each other along a transverse direction, e.g. that of the vehicle. For example, the cross-members are extruded at the same time as other parts of the casing. The casing thereby pre-defines a plurality of compartments wherein the modules are correspondingly placed during the assembly of the battery.

However, in order to be able to correctly insert the modules into the compartments, the compartments are dimensioned so as to permit a functional clearance between the cross-members and the modules. The clearances are typically about 5 mm on both sides of the cross-members.

Furthermore, the cross-members as such, in order to resist the forces that the lateral impact could cause, are dimensioned to resist buckling. Typically, thereof is achieved by means of a rectangular tube 25 mm wide and a few millimeters thick, generally made of metal.

Thereby, two longitudinally consecutive modules are typically separated by a space which extends over at least 35 mm (25 mm+2×5 mm) and does not store energy. Thereof has a negative impact on the compactness of the battery and the energy density thereof, e.g. expressed in W·h/L (watt·hour per liter).

### SUMMARY OF THE INVENTION

A goal of the invention is thus to provide a battery having a better energy density, while maintaining a comparable resistance to the lateral impacts the vehicle may be subjected to.

To this end, the subject matter of the invention is a battery for electrical or hybrid vehicle, comprising:
a casing defining a housing extending along a longitudinal direction and along a transverse direction perpendicular to the longitudinal direction,
a plurality of cross-members directly mounted onto the casing and extending along the transverse direction between a first lateral edge and a second lateral edge of the casing, opposite each other transversely, and
a plurality of assemblies, each of the assemblies including electrochemical cells extending successively along the transverse direction and secured to one another,
   the cross-members and the assemblies being arranged successively against one other in the longitudinal direction in the housing so that there is no mechanical clearance between the cross-members and the assemblies, the assemblies and/or cross-members being attached to the casing.

According to particular embodiments, the battery comprises one or a plurality of the following features, taken individually or according to all technically possible combinations:
at least some of the cross-members comprise a first part located longitudinally between two of the assemblies and having a material thickness along the longitudinal direction of less than 20 mm, preferably less than 10 mm;
the casing comprises a bottom, at least some of the cross-members:
   comprising a second part fastened to the first part on the side opposite the bottom along a third direction perpendicular to the longitudinal direction and to the transverse direction, or
   comprising a second part fastened to the first part on the side opposite the bottom in the third direction, and at least two layers of flexible material fastened to the second part, the second part abutting against two of the assemblies via the two layers of flexible material;
at least some of the cross-members have a T-shaped or H-shaped cross-section perpendicularly to the transverse direction;
each of the assemblies further comprises a central plate extending perpendicularly to the transverse direction, the electrochemical cells being located transversely on both sides of the central plate;
each of the assemblies further comprises: two lateral plates extending perpendicularly to the longitudinal direction and located longitudinally on both sides of the electrochemical cells; and at least two layers of glue or two layers of flexible material located longitudinally between the electrochemical cells and the two lateral plates, respectively;
each of the assemblies further comprises two end plates extending perpendicularly to the transverse direction and located transversely on both sides of the electrochemical cells, the battery further comprising longitudinal tie rods, the tie rods extending through housings defined by the two end plates and through orifices defined by transverse ends of the cross-members, respectively;
each of the two end plates comprises at least one pin on a first face, and defines at least one orifice on a second face opposite longitudinally to the first face, the pin of one of the two end plates of one of the assemblies being located in the orifice of one of the two end plates of another of the assemblies;
said pin on the first face comprises a frustoconical or triangular part and extends through an intermediate orifice defined by one of the cross-members, said part and said intermediate orifice being suitable for moving said cross-member toward the casing in a third direction perpendicular to the longitudinal direction and to the transverse direction by a cam effect when said pin is inserted longitudinally into said orifice on the second face;
the battery further comprises angle brackets welded to transverse ends of the cross-members and fastened to the casing, the angle brackets being suitable for transmitting transverse forces between the cross-members and the casing; and
the casing defines one or a plurality of longitudinal rails suitable for facilitating a guiding of the assemblies and of the cross-members during the assembly of the battery, and/or for serving as a fastening support for the assemblies and/or the cross-members.

A further subject matter of the invention is a method for obtaining an assembly of a battery such as described hereinabove, comprising:
clamping the cross-members and the assemblies against each other along a direction of clamping so as to obtain a clamped system wherein the cross-members extend along a transverse direction of mounting perpendicular to the direction of clamping, the electrochemical cells of each of the assemblies extending successively in the transverse direction of mounting, the cross-members and assemblies being located successively in the direction of clamping, and
fastening, on the casing, the cross-members and/or the assemblies so as to obtain a fastened system, the fastened system being located in the housing and oriented relative to the casing in such a way that the direction of clamping is parallel to the longitudinal direction defined by the battery in the assembled state, and the transverse direction of mounting is parallel to the transverse direction defined by the battery in the assembled state, the cross-members of the fastened system extending between the first and the second lateral edge of the casing and being directly mounted onto the casing.

According to particular embodiments, the method has one or a plurality of the following features, taken individually or according to all technically possible combinations:
the clamping of the cross-members and of the assemblies against each other takes place in the housing, the direction of clamping being parallel to the longitudinal direction and the transverse direction of mounting being parallel to the transverse direction during the clamping;
the clamping comprises clamping sub-steps so as to obtain the clamped system progressively by successive aggregations of some of the cross-members and some of the assemblies over time, and the fastening comprises fastening sub-steps, each of the fastening sub-steps following one of the clamping sub-steps over time, to progressively fasten the clamped system over time; and
the clamping of the cross-members and assemblies against each other is carried out outside the housing, the clamping system comprising tie rods extending along the direction of clamping and of the clamping members, the cross-members and assemblies being fitted onto the tie rods, and the clamping members being arranged on the tie rods to compress the assemblies and cross-members in the direction of clamping, and the fastening onto the casing of the clamping system comprises a movement as a whole of the clamping system in the housing.

### BRIEF DESCRIPTION OF THE DRAWINGS

The invention will be better understood upon reading the following description, given only as an example and making reference to the enclosed drawings, wherein:

FIG. 1 is a perspective view of a battery according to the invention,

FIG. 2 is a perspective view of the battery shown in FIG. 1, with some of the assemblies omitted, and some of the electrochemical cells and electrical connectors omitted for one of the assemblies shown,

FIG. 3 is a perspective view of one of the assemblies of the battery shown in FIG. 1,

FIG. 4 is a view of the battery shown in FIG. 1, in cross-section along a plane perpendicular to the transverse direction,

FIG. 5 is a perspective view of a part of the battery shown in FIG. 1, the casing being omitted to better show the angles, and

FIG. 6 is a perspective view of a cross-member and two angle brackets of the battery shown in FIG. 1, at another angle compared to FIG. 5.

### DETAILED DESCRIPTION OF PREFERRED EMBODIMENTS

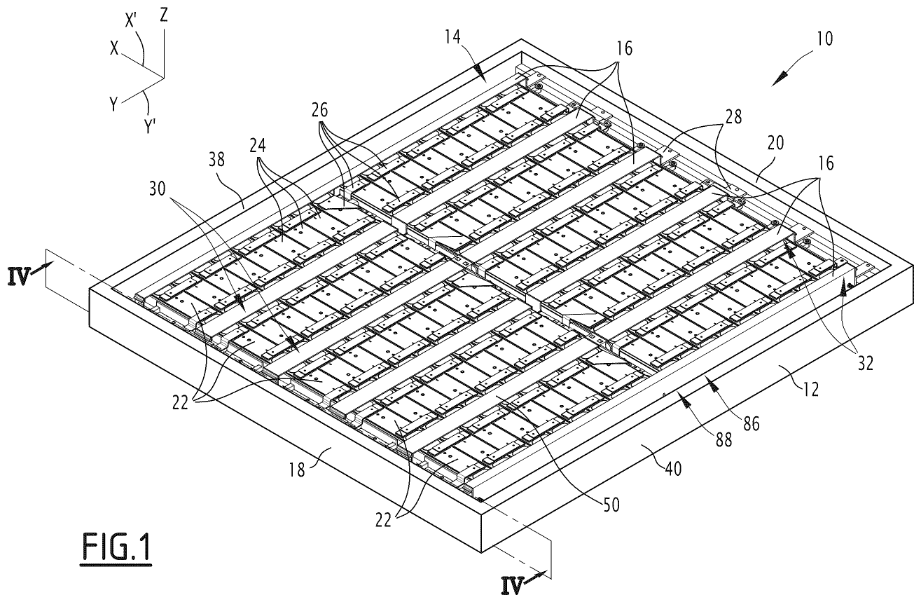

A battery 10 according to the invention, is described with reference to FIGS. 1 to 6.

The battery 10 is e.g. intended to be placed in an electric or hybrid motor vehicle (not shown).

As can be seen in FIG. 1, the battery 10 comprises a casing 12 defining a housing 14 extending along a longitudinal direction X which is e.g. the direction of advance of the vehicle, and along a transverse direction Y perpendicular to the longitudinal direction and which is e.g. the transverse direction of the vehicle.

Optionally, the battery 10 comprises a cover (not shown) for closing the casing 12.

In a variant, the battery 10 is without a cover and advantageously mounted in direct connection with the floor of the vehicle. The battery 10 is e.g. glued to a lower surface of the floor.

Furthermore, a third direction Z is defined perpendicular to the longitudinal direction X and to the transverse direction Y, and which is e.g. intended to be substantially vertical when the vehicle is situated on a horizontal surface (not shown).

The battery 10 further comprises a plurality of cross-members 16 directly mounted onto the casing 12 and extending along the transverse direction Y between a first lateral edge 18 and a second lateral edge 20 of the casing 12, transversely opposite each other. The battery further comprises a plurality of assemblies 22, each of the assemblies comprising electrochemical cells 24 extending successively along the transverse direction Y and mechanically secured to one another.

The battery 10 further comprises electrical connectors 26 arranged in the assemblies to connect the electrochemical cells 24 to each other, and between the assemblies 22, to connect the assemblies to each other.

Advantageously, the battery 10 further comprises angle brackets 28 which are fastened, e.g. welded, to transverse ends 30, 32 of the cross-members 16 and are fastened to the casing 12.

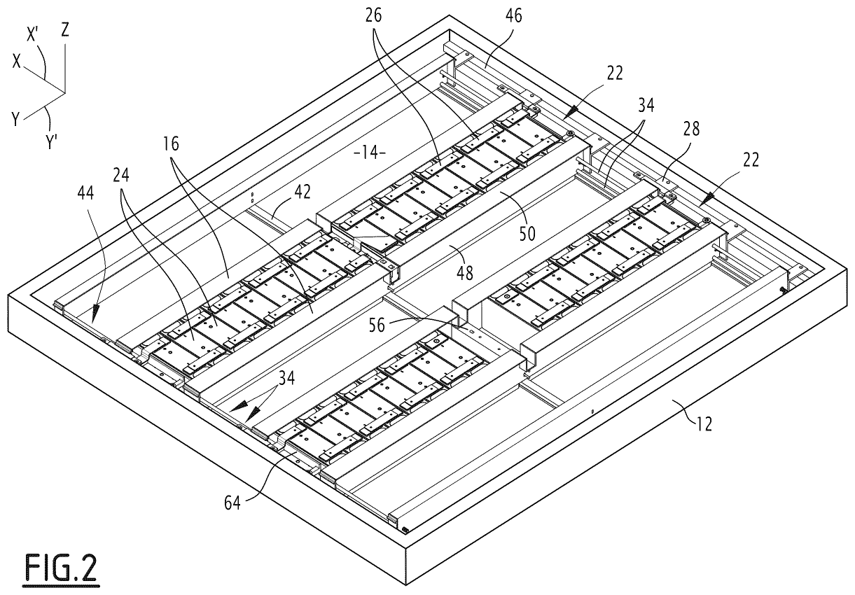

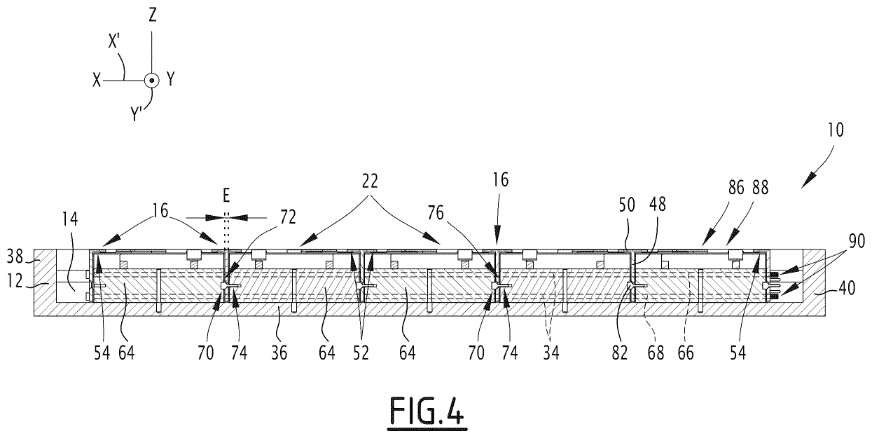

According to a particular embodiment, the battery 10 further comprises longitudinal tie rods 34 (FIGS. 2 and 4) the role of which in assembling the battery will be explained below.

The battery 10 further comprises fastening members (not shown), such as screws, for fastening the assemblies 22 and the cross-members 16 to the casing 12.

In the example, the battery 10 comprises five assemblies 22 and six cross-members 16. Four of the six cross-members 16 are interposed longitudinally between the assemblies 22, and two cross-members are called, longitudinally, “end” cross-members since same run along only one of the assemblies, respectively.

According to other embodiments (not shown), the number of assemblies 22 is less than five or more than five, and the number of cross-members 16 is less than six or more than six.

According to a variant (not shown), each of the cross-members 16 is situated longitudinally between two of the assemblies 22. The number of cross-members 16 is then equal to the number of assemblies 22 minus one.

The casing 12 has e.g. a parallelepiped shape, advantageously flattened in the third direction Z, since the battery is e.g. intended to be integrated in the lower part of the vehicle, e.g. under a passenger compartment.

In addition to the first lateral edge 18 and the second lateral edge 20, the casing 12 comprises a bottom 36, and a third lateral edge 38 and a fourth lateral edge 40 opposite each other in the longitudinal direction X.

Unlike the prior art, the casing 12 does not predefine, longitudinally, successive compartments into which the assemblies 22 would be inserted.

The casing 12 defines e.g. longitudinal rails 42, 44, 46 (FIG. 2) suitable for facilitating a guiding of the assemblies 22 and of the cross-members 16 during a mounting of the battery 10, and to serve as a fastening support for the assemblies and the cross-members.

The rail 42 extends e.g. protruding from the bottom 36.

For example, the rails 44, 46 extend on the first lateral edge 18 and on the second lateral edge 20, respectively.

The cross-members 16 and the assemblies 22 are arranged successively in the housing 14 against each other in the longitudinal direction X, so that there is no mechanical clearance between the successive elements, the assemblies and the cross-members being fastened to the casing 12. Thereby, the cross-members 16 are more resistant to buckling in the event of a lateral impact (along the transverse direction Y) on the vehicle, since same are held by the assemblies 22.

In the example, the cross-members 16 and the assemblies 22 form a simple alternation (an assembly 22 followed by a cross-member 16 followed by an assembly 22, etc.).

According to variants (not shown), the alternation may be more complex (e.g. two assemblies 22 followed by one cross-member 16 followed by two assemblies 22, etc.).

According to still other variants, the alternation may be irregular (e.g. one assembly 22 followed by one cross-member 16 followed by two assemblies 22 followed by one cross-member 16, etc.).

More generally, the cross-members 16 may separate one or two assemblies 22, or even more, or may be situated in the end position (i.e. with an assembly 22 only on one side).

Unlike the prior art, the cross-members 16 are not pre-existing or pre-installed in the casing 12. When the assemblies 22 are installed, there are no predefined compartments that would require mechanical clearance between the assemblies 22 and the cross-members 16. The cross-members 16 are installed concomitantly with the assemblies 22.

At least some of the cross-members 16, in the example same which are not end cross-pieces, have, perpendicularly to the transverse direction Y, a T-shaped cross-section (FIG. 4).

According to variants not shown, the cross-section is H-shaped, C-shaped or forms a rectangle (the cross-member is then tubular).

In the example, the end cross-members 16 have a cross-section different from the cross-section of the non-end cross-members, e.g. in the shape of a C.

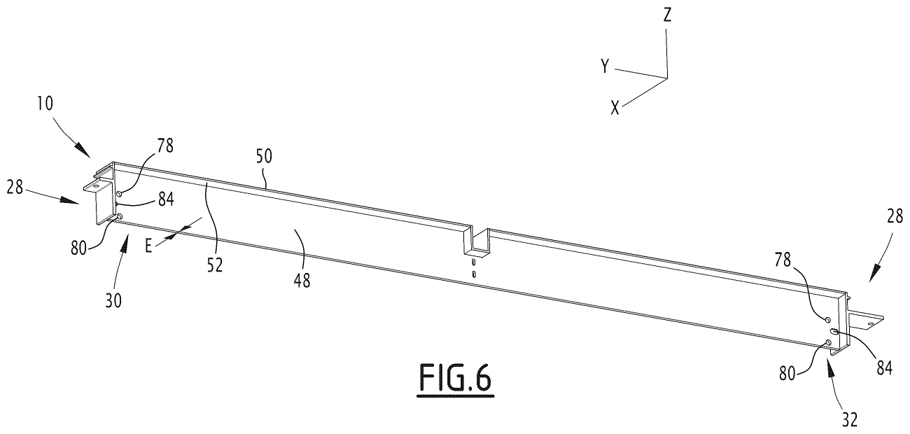

As can be seen in FIGS. 4 and 6, the cross-members 16 comprise e.g. a first part 48 extending perpendicularly to the longitudinal direction X. In the example, all the cross-members 16 further comprise a second part 50 secured to the first part on the side opposite the bottom 36.

The first part 48 of the non-end cross-members 16 is situated longitudinally between two of the assemblies 22. The first part 48 of all the cross-members 16 advantageously has a thickness E of material along the longitudinal direction X of less than 20 mm, preferably less than 10 mm. Thereby, two assemblies 22 which are consecutive longitudinally, are separated by less than 20 mm, advantageously less than 10 mm.

The second part 50 extends e.g. perpendicularly to the third direction Z.

The second part 50 is e.g. integral with to the first part 48.

The second part 50 of the non-end cross-members 16 abuts against two of the assemblies 22 along the third direction Z via two layers 52 of flexible material, e.g. a foam.

In a variant, the second part 50 abuts directly on the assemblies 22.

The second part 50 of the end cross-members 16 abuts on only one of the assemblies 22, by means of a layer 54 of flexible material, or, in a variant, directly.

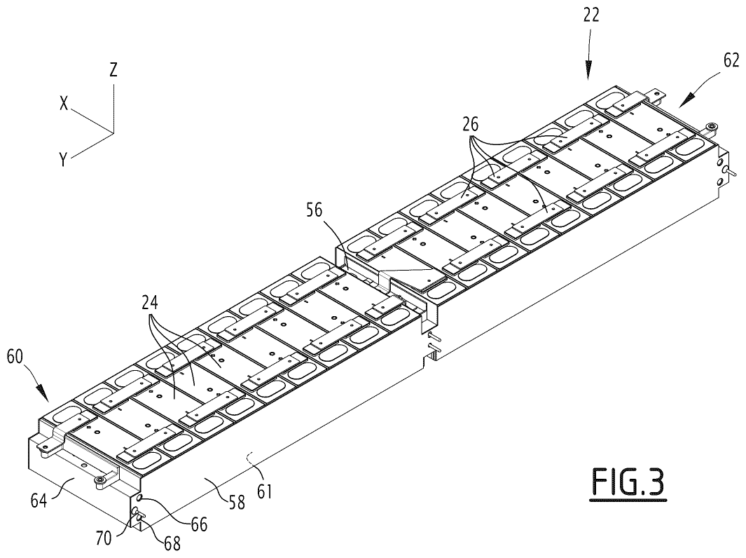

In the example, each of the assemblies 22 comprises a central plate 56 (FIGS. 2 and 3) extending perpendicularly to the transverse direction Y, the electrochemical cells 24 being situated transversely on both sides of the central plate.

Each of the assemblies 22 comprises e.g. two lateral plates 58, 60 (FIG. 3) extending perpendicularly to the longitudinal direction X and situated on both sides of the electrochemical cells 24 longitudinally, and at least two layers of adhesive 61 or two layers of flexible material (not shown) situated longitudinally between the electrochemical cells 24 and the two lateral plates 58, 60, respectively.

Each of the assemblies 22 comprises e.g. two end plates 62, 64 extending perpendicularly to the transverse direction Y, transversally on both sides of the electrochemical cells 24.

The central plates 56 are advantageously suitable for resisting longitudinal forces which would be applied thereto by the cross-members 16, and thus contribute to reducing the risk of buckling of the cross-members in the event of a lateral impact on the vehicle. The plates 56 advantageously form spacers between the cross-members 16

Each of the two end plates 62, 64 advantageously defines two longitudinal through cavities 66, 68.

Each of the two end plates 62, 64 comprises at least one pin 70 (FIGS. 3 and 4) on a first face 72, and defines at least one orifice 74 on a second face 76 opposite longitudinally to the first face, the pin 70 of one of the two end plates 62, 64 of one of the assemblies 22 being located in the orifice 74 of one of the two end plates 62, 64 of another of the assemblies 22.

The tie rods 34 extend into the housings 66, 68 defined by the end plates 62, 64, and run through orifices 78, 80 defined by the transverse ends 30, 32 of the cross-members 16. In the example, the tie rods 34 also cross through the two lateral plates 58, 60 of each of the assemblies 22.

Each of the pins 70 on the first face 72 comprises e.g. a frustoconical or triangular part 82 and crosses through an intermediate orifice 84 (FIG. 6) defined by each of the cross-members 16. Said part 82 and said intermediate orifice 84 are suitable for moving the cross-members 16 toward the casing 12 along the third direction Z by the cam effect when said pin 70 is inserted longitudinally into said orifice 74 on the second face 76.

In a variant (not shown), the pins are e.g. cylindrical.

The angle brackets 28 are advantageously suitable for transmitting transverse forces between the cross-members 16 and the casing 12.

In the example, at least the angle brackets 28 and the end plates 62, 64 are screwed onto the casing 12.

A first method of assembling the battery 10 will now be described.

The first method comprises a step of clamping the cross-members 16 and the assemblies 22 against each other along a direction of clamping X′ so as to obtain a clamped system 86, and a step of fastening the cross-members 16 and/or the assemblies 22 to the casing 12 so as to obtain a fastened system 88.

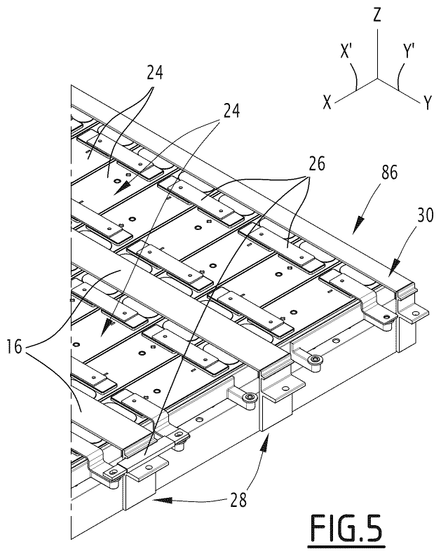

In the clamped system 86 (FIG. 5), the cross-members 16 extend along a transverse direction of mounting Y′ perpendicular to the direction of clamping X′. The electrochemical cells 24 of each of the assemblies 22 extend successively along the transverse direction of mounting Y′. The cross-members 16 and the assemblies 22 are situated successively in the direction of clamping X′, forming, in the example, a simple alternation.

The fastened system 88 (FIG. 1) is located in the housing 14 and oriented with respect to the casing 12 in such a way that the direction of clamping X′ is parallel to the longitudinal direction X defined by the battery 10 in the assembled state, and that the transverse direction of mounting Y′ is parallel to the transverse direction Y defined by the battery in the assembled state. The cross-members 16 of the fastened system 88 extend between the first lateral edge 18 and the second lateral edge 20 of the casing 12 and are attached to the casing 12.

In the first method, the cross-members 16 and the assemblies 22 are advantageously clamped against each other in the housing 14. The direction of clamping X′ is parallel to the longitudinal direction X, and the transverse direction of mounting Y′ is parallel to the transverse direction Y starting from the clamping step.

Advantageously, the rails 42, 44, 46 facilitate the positioning and the clamping of the assemblies 22 and of the cross-members 16. The angle brackets 28 can slide on the rails 44, 46.

The clamping and fastening steps are advantageously interleaved over time. Advantageously, the clamping comprises clamping sub-steps so as to obtain the clamped system 86 progressively, by successive aggregations over time. The fastening comprises fastening sub-steps, each of the fastening sub-steps following one of the clamping sub-steps over time, to progressively fasten the clamped system 86 over time.

For example, the assemblies 22 and the cross-members 16 are clamped and then fastened, one by one. Each new element is clamped in the housing 14 against the previous elements along the longitudinal direction X, and fastened to the casing 12.

In a variant, elements are added in groups of more than one element, e.g. two or a plurality of elements.

The end plates 62, 64 of each of the assemblies 22, and the angle brackets 28 are e.g. screwed onto the casing 12. Thereby, the cross-members 16 are advantageously fastened by means of the angle brackets 28.

According to particular embodiments, other elements of the assemblies 22, or parts of the cross-members 16, are fastened to the casing 12.

A second method of assembling the battery 10 will now be described. The second method is analogous to the first method, and comprises a clamping step and a fastening step. Hereinafter, only the differences will be described in detail.

In the second method, the clamping step does not take place in the housing 14 but outside same, e.g. the clamping is carried out completely before the fastening.

During the clamping step, the direction of clamping X′ and the transverse direction of mounting Y′ are thus not necessarily parallel to the longitudinal direction X and to the transverse direction Y, respectively, which will be defined later by the battery 10 in the assembled state in the housing 14. In simpler words, the clamped system 86 is not located in the housing 14 and can thus have any orientation with respect to the casing 12.

The clamped system 86 advantageously comprises the tie rods 34 which extend in the direction of clamping X′, and of the clamping members 90.

To carry out the clamping, the cross-members 16 and the assemblies 22 are e.g. fitted onto the tie rods 34. Then, the clamping members 90 are arranged on the tie rods 34 to compress the assemblies 22 and the cross-members 16 along the direction of clamping X′. For example, the clamping members 90 are screwed onto one end of each of the tie rods 34.

For example, by means of the pins 70 of the end plates 62, 64, the positioning of the cross-members 16 perpendicular to the direction of clamping X′ and to the transverse direction of mounting Y′ is facilitated.

In order to achieve the fastening onto the casing 12, the clamped system 86 is moved as a whole in the housing 14. Then, the clamped system 86 is fastened to the casing 12, e.g. by means of screws, which makes it possible to directly mount the cross-members 16 onto the casing 12.

The second method has the advantage that the clamping step is carried out without being hindered or constrained by the presence of the casing 12. In the example, the method requires tie rods 34, which are additional parts, but guarantee a very good clamping, very homogeneous transversely.

Due to the features described hereinabove, the battery 10 has a better energy density, while keeping an at least comparable resistance to the lateral impacts that the vehicle may be subjected to.

Indeed, the assemblies 22 are not inserted into compartments predefined by cross-members of the casing 12. On the other hand, the cross-members 16 are directly mounted to the casing 12 during the assembly of the battery 10. The cross-members 16 and the assemblies 22 can thereby be clamped against each other without any clearance. Whether the clamping takes place in the casing 12 (first method) or outside the casing 12 (second method), the fastening of the cross-members 16 does not prevent such correct clamping. As a result, the distance between two longitudinally consecutive assemblies 22 is reduced. The energy density of the battery 10 is thereby increased.

Furthermore, because of the clamping, the assemblies 22 limit the possibility of the cross-members 16 being subjected to buckling in the event of a lateral impact, by preventing the cross-members 16 from bending along the longitudinal direction X. Thereby, it is possible to use cross-members 16 the first part 48 of which, located between two consecutive assemblies 22, is thinner, all other things being otherwise the same. Thereof again serves to increase the energy density of the battery 10.

The possible central plates 56 of the assemblies 22 advantageously reinforce such effect.

For example, if the first part 48 has a thickness E of material less than 20 mm, or even less than 10 mm, two consecutive assemblies 22 are separated by only 20 mm, or even 10 mm, thereof being to be compared with the 35 mm mentioned in the preamble.

Moreover, the invention further makes a better charging rate of the battery 10 in the fast charging mode, a better behavior of the battery in the event of thermal runaway, and a longer life of the electrochemical cells 24, due to an improvement in the heat dissipation and by means of a reduction in the heat gradient inside the electrochemical cells.

1. A battery for an electric or hybrid vehicle, the battery comprising:
a casing defining a housing extending along a longitudinal direction and along a transverse direction perpendicular to the longitudinal direction,
a plurality of cross-members directly mounted onto the casing and extending along the transverse direction between a first lateral edge and a second lateral edge of the casing opposite each other transversely, and
a plurality of assemblies, each of the assemblies including electrochemical cells extending successively along the transverse direction and secured to one another, the cross-members and the assemblies being arranged successively against one other in the longitudinal direction in the housing so that there is no mechanical clearance between the cross-members and the assemblies, the assemblies and/or cross-members being fastened to the casing.

2. The battery according to claim 1, wherein at least some of the cross members comprise a first portion located longitudinally between two of the assemblies and having a thickness of material along the longitudinal direction of less than 20 mm, preferably less than 10 mm.

3. The battery according to claim 2, wherein the casing comprises a bottom, at least some of the cross-members:
comprising a second part fastened to the first part on the side opposite the bottom in a third direction perpendicular to the longitudinal direction and to the transverse direction, or
comprising a second part fastened to the first part on the side opposite the bottom along the third direction, and at least two layers of flexible material fastened to the second part, the second part abutting against two of the assemblies via the two layers of flexible material.

4. The battery according to claim 1, wherein at least some of the cross-members have a “T” or “H” cross-section perpendicularly to the transverse direction.

5. The battery according to claim 1, wherein each of the assemblies further comprises a central plate extending perpendicular to the transverse direction, the electrochemical cells being located transversely on both sides of the central plate.

6. The battery according to claim 1, wherein each of the assemblies furthermore comprises:
two side plates extending perpendicularly to the longitudinal direction and located longitudinally on both sides of the electrochemical cells, and
at least two layers of glue or two layers of flexible material located longitudinally between the electrochemical cells and the two side plates, respectively.

7. The battery according to claim 1, wherein each of the assemblies further comprises two end plates extending perpendicular to the transverse direction and located transversely on both sides of the electrochemical cells, the battery further comprising longitudinal tie rods, the tie rods extending respectively through housings defined by the two end plates and through orifices defined by transverse ends of the cross-members.

8. The battery according to claim 7, wherein each of the two end plates comprises at least one pin on a first face, and defines at least one orifice on a second face longitudinally opposite the first face, the pin of one of the two end plates of one of the assemblies being located in the orifice of one of the two end plates of another of the assemblies.

9. The battery according to claim 8, wherein said pin on the first face comprises a frustoconical or triangular portion and passes through an intermediate orifice defined by one of the cross-members, said portion and said intermediate orifice being adapted for moving said cross-member toward the casing along a third direction perpendicular to the longitudinal direction and to the transverse direction by cam effect when said pin is inserted longitudinally into said orifice on the second face.

10. The battery according to claim 1, further comprising angle brackets welded to transverse ends of the cross-members and fastened to the casing, the angle brackets being adapted for transmitting transverse forces between the cross-members and the casing.

11. The battery according to claim 1, wherein the casing defines one or a plurality of longitudinal rails adapted for facilitating the guiding of the assemblies and of the cross-members during an assembly of the battery, and/or to serve as a fastening support for the assemblies and/or the cross-members.

12. A method of assembling a battery as described in claim 1, comprising:
clamping the cross-members and the assemblies against each other along a direction of clamping so as to obtain a clamped system wherein the cross-members extend along a transverse direction of mounting perpendicular to the direction of clamping, the electrochemical cells of each of the assemblies extending successively in the transverse direction of mounting, the cross-members and assemblies being located successively in the direction of clamping, and
fastening, on the casing, the cross-members and/or the assemblies so as to obtain a fastened system, the fastened system being located in the housing and oriented relative to the casing in such a way that the direction of clamping is parallel to the longitudinal direction defined by the battery in the assembled state, and that the transverse direction of mounting is parallel to the transverse direction defined by the battery in the assembled state, the cross-members of the fastened system extending between the first lateral edge and the second lateral edge of the casing by being directly mounted on the casing.

13. The method according to claim 12, wherein the clamping of the cross-members and of the assemblies against each other is carried out in the housing, the direction of clamping being parallel to the longitudinal direction and the transverse direction of mounting being parallel to the transverse direction during the clamping.

14. The method according to claim 13, wherein:
the clamping comprises clamping sub-steps so as to obtain the clamped system progressively by successive aggregations of some of the cross-members and some of the assemblies over time, and
the fastening comprises fastening sub-steps, each of the fastening sub-steps following one of the clamping sub-steps over time, to progressively fasten the clamped system over time.

15. The method according to according to claim 12, wherein:
the cross-members and assemblies are clamped against each other outside the housing, the clamped system comprising tie rods extending along the direction of clamping and of the clamping members, the cross-members and the assemblies being fitted onto the tie rods, and the clamping members being arranged on the tie rods so as to compress the assemblies and the cross-members along the direction of clamping;
the fastening on the casing of the clamped system comprises a displacement as a whole of the clamped system in the housing.
